(19) United States
(12) Patent Application Publication
(10) Pub. No.: US 2012/0113239 A1
(43) Pub. Date: May 10, 2012

(54) SYSTEM AND METHOD FOR DISPLAYING AN IMAGE STREAM

(76) Inventors: Hagai KRUPNIK, Nofit (IL); Ady Ecker, Nes-Ziona (IL)

(21) Appl. No.: 13/291,245

(22) Filed: Nov. 8, 2011

Related U.S. Application Data
(60) Provisional application No. 61/411,178, filed on Nov. 8, 2010.
(60) Provisional application No. 61/479,986, filed on Apr. 28, 2011.

(51) Int. Cl. H04N 7/18

(52) U.S. Cl. 348/65; 348/E07.085

(57) ABSTRACT

A system and method to display an image stream captured by an in vivo imaging capsule may include selecting a first subset of images from an original image stream for display as a reduced image stream. The reduced image stream may be displayed in a main image window on a monitor. A second subset of images may be obtained by subtracting the first subset of images from the original image stream. An image from the first subset of images may be selected for display in the main image window during a first time slot, and an image from the second subset of images is selected for display in a peripheral window. The selected images may be displayed simultaneously.

### PRIOR APPLICATION DATA

The present application claims benefit from prior provisional application 61/411,178 filed Nov. 8, 2010 and prior provisional application 61/479,986 filed Apr. 28, 2010, each of which being incorporated by reference herein in its entirety.

### FIELD OF THE INVENTION

The present invention relates to a method and system for displaying and/or reviewing image streams. More specifically, the present invention relates to a method and system for effective display of an in vivo image stream generated by a capsule endoscope.

### BACKGROUND OF THE INVENTION

An image stream may be assembled from a series of still images and displayed to a user. The images may be created or collected from various sources, for example using Given Imaging Ltd.'s commercial PillCam® SB2 or ESO2 swallowable capsule products. For example, U.S. Pat. Nos. 5,604,531 and/or 7,009,634 to Iddan et al., assigned to the common assignee of the present application and incorporated herein by reference, teach an in-vivo imager system which in one embodiment includes a swallowable or otherwise ingestible capsule. The imager system captures images of a lumen such as the gastrointestinal (GI) tract and transmits them to an external recording device while the capsule passes through the lumen. The capsule may advance along lumen portions at different progress rates, moving at an inconsistent speed, which may be faster or slower depending on the peristaltic movement of the intestines. Large numbers of images may be collected for viewing and, for example, combined in sequence. Images may be selected for display from the original image stream, and a subset of the original image stream may be displayed to a user. The time it takes to review the complete set of captured images may be relatively long, for example may take several hours. Preferably, in order to shorten the review time, the reduced set of images may be generated. A reviewing physician may want to view a reduced set of images, which includes images which are important or clinically interesting, and which does not omit any relevant clinical information. The reduced or shortened movie may include images of clinical importance, such as images of selected predetermined locations in the gastrointestinal tract, and images with pathologies or abnormalities.

For example, U.S. Pat. No. 7,986,337 to Davidson et al., assigned to the common assignee of the present application and incorporated herein by reference, teaches in one embodiment a method of editing an image stream, for example by selecting images which follow predetermined criteria. U.S. Pat. No. 7,505,062 to Davidson et al., assigned to the common assignee of the present application and incorporated herein by reference, teaches in one embodiment a method for displaying images from the original image stream across a plurality of consecutive or sequential time slots, wherein in each time slot a set of consecutive images from the original image stream is displayed, thereby increasing the rate at which the original image stream can be reviewed without reducing image display time.

An in-vivo imager system may collects a series of still images as it traverses the GI (gastrointestinal) tract. The images may be later presented as a stream of images of the traverse of the GI tract. The in-vivo imager system may collect a large volume of data, as the capsule may take several hours to traverse the GI tract, and may record images at a rate of, for example, two images every second, or other rates, resulting in the recordation of thousands of images. The image recordation rate (or frame capture rate) may be varied. The imaging procedure may focus on a specific organ of the GI tract, e.g. the esophagus, the small bowel or the colon, and different procedure types may have different typical frame capture rates and varying total procedure time. For example, the esophagus procedure may typically take 30 minutes, while the small bowel procedure may take 8-15 hours.

A preview image stream or a reduced image stream containing for example about 5,000 frames selected from the total number of 50,000 or 70,000 recorded images captured by a swallowable capsule during a colon imaging procedure, over a period of for example 5-10 hours, may be presented to the user for review. Other numbers of frames may be used. In one embodiment, a frame display rate is preset, but the user can increase or decrease the frame display rate at anytime during the review process, and/or define a different frame display rate. In general, a user may try to set the frame display rate to the highest rate where the user can quickly and effectively review the image stream without missing important information that may be present in any of the images included in the stream. The rate at which a user can effectively review an image stream is limited by a physiological averaging effect that is known to exist at around 15-25 frames per second (although this number varies for different users and image streams) above which certain details in individual images displayed in the stream may be filtered out due to the eye/brain perception and processing of the displayed images.

When reviewing medical information in an image stream, it is important not to miss any images which include information which indicates or suggests the existence of a pathology. If a subset of the image stream is reviewed, the rest of the images may contain important information which may be missed if not presented to the viewer.

Therefore, a need exists for a system and method that enable a user to increase the rate at which the user can efficiently review an image stream, while not missing important information which may exist in images which were not selected for display according to the predetermined selection criteria.

### SUMMARY OF THE INVENTION

A system and method to display an image stream captured by an in vivo imaging capsule may include selecting a first subset of images from an original image stream for display as a reduced image stream. The reduced image stream may be displayed in a main image window on a monitor. A second subset of images may be obtained by subtracting the first subset of images from the original image stream. An image from the first subset of images may be selected for display in the main image window during a first time slot, and an image from the second subset of images is selected for display in a peripheral window. The selected images may be displayed simultaneously.

### BRIEF DESCRIPTION OF THE DRAWINGS

The present invention will be understood and appreciated more fully from the following detailed description taken in conjunction with the drawings in which:

FIG. 1 shows a schematic diagram of an in-vivo imaging system according to an embodiment of the present invention;

FIGS. 2A-2E depict portions of a display or viewing area according to an embodiment of the present invention;

FIG. 3A illustrates an exemplary portion of an original image stream and the corresponding portion of an edited image stream according to an embodiment of the invention;

FIG. 3B illustrates the displayed images of the image stream portion according to an embodiment of the invention;

FIG. 4 is a flowchart depicting a method for displaying an edited image stream according to an embodiment of the invention;

FIG. 5 is an exemplary user interface which may be displayed according to an embodiment of the present invention; and

FIGS. 6A and 6B are views of user displays or viewing areas according to an embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, throughout the specification discussions utilizing terms such as “processing,” “computing,” “storing,” “calculating,” “determining,” “evaluating,” “measuring,” “providing,” “transferring,” “outputting,” “inputting,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

A system and method according to one embodiment of the invention enable a user to see images in an edited image stream for a longer period of time without increasing the overall viewing time of the edited image stream. Additionally or alternatively, the system and method described according to one embodiment may be used to increase the rate at which a user can review the edited image stream without sacrificing details that may be depicted in the stream. In certain embodiments, the images are collected from a swallowable or otherwise ingestible capsule traversing the GI tract. The images may be combined into an image stream or movie. An original image stream or complete image stream may be created, that includes all images (e.g., complete set of frames) captured or received during the imaging procedure, while a reduced or edited image stream may include a selection of the images (e.g., subset of frames), selected according to one or more predetermined criteria. In some embodiments, images may be omitted from an original image stream, e.g. an original image stream may include fewer images than the number of images captured by the swallowable capsule. For example, images which are oversaturated, blurred, include intestinal contents or turbidity, and/or images which are very similar to neighboring images, may be removed from the full set of images captured by the imaging capsule, and the original stream may include a subset of the images captured by the imaging capsule. In such cases, the reduced image stream may include a reduced subset of images selected from the original image stream according to predetermined criteria.

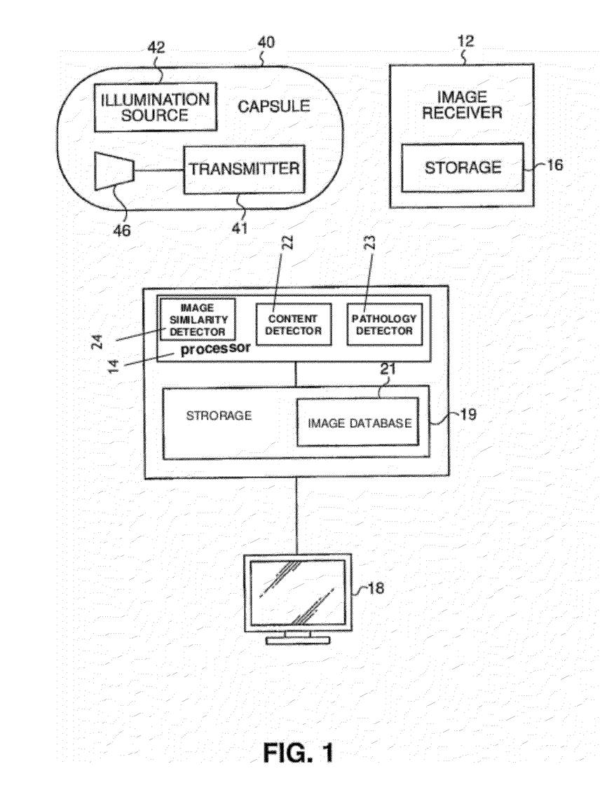

Reference is made to FIG. 1, which shows a schematic diagram of an in-vivo imaging system according to one embodiment of the present invention. In an exemplary embodiment, the system comprises a capsule 40 having one or more imagers 46, for capturing images, one or more illumination sources 42, for illuminating the body lumen, and a transmitter 41, for transmitting image and possibly other information to a receiving device. Typically, the image capture device may correspond to embodiments described in U.S. Pat. No. 5,604,531 and/or in U.S. Pat. No. 7,009,634 to Iddan et al., and/or in U.S. patent application Ser. No. 11/603,123 to Gilad, but in alternate embodiments may be other sorts of image capture devices. The images captured by the imager system may be of any suitable shape including for example circular, square, rectangular, octagonal, hexagonal, etc. Typically, located outside the patient's body in one or more locations are an image receiver 12, typically including an antenna or antenna array, an image receiver storage unit 16, a data processor 14, a data processor storage unit 19, and an image monitor 18, for displaying, inter alia, images recorded by the capsule 40. Typically, data processor storage unit 19 includes an image database 21.

Typically, data processor 14, data processor storage unit 19 and monitor 18 are part of a personal computer or workstation, which includes standard components such as processor 14, a memory, a disk drive, and input-output devices such as a mouse and keyboard, although alternate configurations are possible. Data processor 14 may include any standard data processor, such as a microprocessor, multiprocessor, accelerator board, or any other serial or parallel high performance data processor. Data processor 14, as part of its functionality, may act as a controller controlling the display of the images (e.g., which images, the location of the images among various windows, the timing or duration of display of images, etc.). Image monitor 18 is typically a conventional video display, but may, in addition, be any other device capable of providing image or other data. The image monitor 18 presents the image data, typically in the form of still and moving pictures, and in addition may present other information. In an exemplary embodiment, the various categories of information are displayed in windows. A window may be for example a section or area (possibly delineated or bordered) on a display or monitor; other windows may be used. Multiple monitors may be used to display image and other data, for example an image monitor may also be included in image receiver 12.

In operation, imager 46 captures images and sends data representing the images to transmitter 41, which transmits images to image receiver 12 using, for example, electromagnetic radio waves. Image receiver 12 transfers the image data to image receiver storage unit 16. After a certain period of time of data collection, the image data stored in storage unit 16 may be sent to the data processor 14 or the data processor storage unit 19. For example, the image receiver 12 or image receiver storage unit 16 may be taken off the patient's body and connected to the personal computer or workstation which includes the data processor 14 and data processor storage unit 19 via a standard data link, e.g., a serial, parallel, USB, or wireless interface of known construction. The image data is then transferred from the image receiver storage unit 16 to an image database 21 within data processor storage unit 19. Typically, the image stream is stored as a series of images in the image database 21, which may be implemented in a variety of known manners. Data processor 14 may analyze the data and provide the analyzed data to the image monitor 18, where a user views the image data. Data processor 14 operates software that, in conjunction with basic operating software such as an operating system and device drivers, controls the operation of data processor 14. Typically, the software controlling data processor 14 includes code written in the C++ language, and may be implemented using various development platforms such as Microsoft's .NET platform, but may be implemented in a variety of known methods.

Data processor 14 may include graphics software or hardware. Data processor 14 may assign one or more scores, ratings or measures to each frame based on a plurality of pre-defined criteria. When used herein, a “score” may be a general score or rating, where (in one embodiment) the higher the score the more likely a frame is to be included in a movie, and (in another embodiment) a score may be associated with a specific property, e.g., a quality score, a pathology score, a similarity score, or another score or measure that indicates an amount or likelihood of a quality a frame has. The data processor 14 may select the frames with scores within an optimal range for display and/or remove those with scores within a sub-optimal range. The scores may represent, for example, a (normal or weighted) average of the frame values or sub-scores associated with the plurality of pre-defined criteria. The subset of selected frames may be played, in sequence, as an edited (reduced) movie or image stream.

The pre-defined criteria may include a measure or likelihood of pathology detected, capsule location (or estimated location, or best guess for a location), capsule motion, orientation, frame capture or transmission rate, and/or similarity between frames. Other criteria may be used to determine how to select the representative image from a group of similar images. For example, the criteria may be based on image quality or parameter information such as the illumination quality of the image. Images that are very dark, or over-saturated, may not be selected for display, since such images may not provide valuable input to the reviewing physician. In another example, images that include a high degree of intestinal content, bubbles or turbid media, may not be selected for display for similar reasons. Other scores which may be assigned to the images, for example by a processor using image processing techniques, may be used for determining which image should be selected for display in the peripheral windows. The images in an original stream and/or in a reduced stream may be sequentially ordered (and thus the streams may have an order) according to the chronological time of capture, or may be arranged according to different criteria (such as degree of similarity between images, color levels, illumination levels, estimated distance of the object in the image from the in vivo device, suspected pathological rating of the images, etc.).

Data processor 14 may include, or may be operationally connected to, an image similarity detector 24. The image similarity detector 24 may determine the degree of similarity between two or more images, e.g. consecutive images in a certain stream, for example by comparing the two or more images or portions thereof. Data processor 14 may also include, or may be operationally connected to, a content detector 22, and/or one or more pathology detectors 23. The content detector 22 may detect intestinal content in the images, and may determine a degree or percentage of content in an image frame, for example turbid media, bubbles, or bile or other solid or liquid content which may obscure the tissue in the image, for example as disclosed in one embodiment or U.S. Pat. No. 7,577,283 to Zinaty et al, assigned to the common assignee of the present application and incorporated herein by reference. Pathology detector 23 may assign a high score or rating to an image which is likely to show pathology, and a low score or rating to an image which is likely to depict healthy tissue. The pathology detector 23 may include, for example, specific pathology detectors such as a polyp detector (for example, as disclosed in one embodiment in U.S. patent application Ser. No. 11/239,392 to Horn), a lesion detector, a blood detector (e.g., as disclosed in PCT Application Number PCT/IL2002/002010), etc.

In some embodiments, an “interesting frame” detector may also be included in data processor 14. Interesting frames may include, for example, frames which depict a specific anatomical landmark (e.g., the duodenum, the cecum, the splenic flexure, the hepatic flexure, etc.) or frames which may otherwise be interesting or important for the reviewing physician for analyzing the movie. Each of detectors 22, 23 and 24 may be, for example, software, code or instructions stored in a memory (e.g., 19) and executed by a processor (e.g. 14), but each detector may be implemented differently, e.g., in hardware. In some embodiments, each of detectors 22, 23 and 24 may be used, for example, for selecting images from the original image stream to create the edited or reduced image stream. In some embodiments, each of detectors 22, 23 and 24 may be used for determining which images will be displayed substantially simultaneously in a single time slot. Other detectors may be used in addition or instead. When used herein, “substantially simultaneously” includes simultaneously, almost simultaneously or concurrently. For example, an image may be displayed in a first window at a time T, and the concurrent images may be displayed at a time (T+delta), wherein delta may indicate, for example, a few fractions of a second up to a few seconds. The replacement of a set of images displayed substantially simultaneously on a monitor may not happen at exactly the same moment, for example replacement may be performed during a short time period, of for example several one-hundredths of a second up to several seconds.

The image data collected and stored may be stored indefinitely, transferred to other locations, manipulated or analyzed. A health professional may, for example, use the images to diagnose pathological conditions or abnormalities of the GI tract, and, in addition, the system may provide information about the location of these pathologies. While, using a system where the data processor storage unit 19 first collects data and then transfers data to the data processor 14, the image data is not viewed in real time, other configurations allow for real time viewing, for example viewing the images on a display or monitor which is part of the image receiver 12.

The image data recorded and transmitted by the capsule 40 may be digital color image data, although in alternate embodiments other image formats may be used. In an exemplary embodiment, each frame of image data includes 399 rows of 399 pixels each, each pixel including bytes for color and brightness, according to known methods. For example, in each pixel, color may be represented by a mosaic of four sub-pixels, each sub-pixel corresponding to primaries such as red, green, or blue (where one primary may be represented twice). The brightness of the overall pixel may be recorded by a one byte (i.e., 0-255) brightness value. Images may be stored, for example sequentially, in data processor storage unit 19. The stored data is comprised of one or more pixel properties, including color and brightness. Other image formats may be used.

Data processor storage unit 19 may store a series of images recorded by a capsule 40. The images the capsule 40 records, for example, as it moves through a patient's GI tract may be combined consecutively to form a series of images displayable as an image stream. When viewing the image stream, the user is typically presented with one or more windows on monitor 18; in alternate embodiments multiple windows need not be used and only the image stream may be displayed. In an embodiment where multiple windows are provided, for example, an image window may provide the image stream, or still portions of that image. Another window may include buttons or other controls that may alter the display of the image; for example, stop, play, pause, capture image, step, fast-forward, rewind, or other controls. Such controls may be activated by, for example, a pointing device such as a mouse or trackball. Typically, the image stream may be frozen to view one frame, speeded up, or reversed; sections may be skipped; or any other method for viewing an image may be applied to the image stream.

In one embodiment, an original image stream, for example an image stream captured by an in vivo imaging capsule, may be edited or reduced according to different selection criteria. Examples of selection criteria disclosed, for example, in paragraph [0032] of US Patent Application Publication Number 2006/0074275 to Davidson et al., assigned to the common assignee of the present application and incorporated herein by reference, include numerically based criteria, quality based criteria, annotation based criteria, color differentiation criteria and/or resemblance to a preexisting image such as an image depicting an abnormality. The edited or reduced image stream may include a reduced number of images compared to the original image stream. In some embodiments, a reviewer may view the reduced stream in order to save time, for example instead of viewing the original image stream. In some embodiments, the viewer may prefer viewing portions of the original image stream substantially simultaneously with portions of the reduced image stream. A reduced/original image stream differentiation need not be used in some embodiments, for example the original image stream may be displayed as described herein.

When viewing an in vivo image stream, the display rate of the images may vary, for example according to the estimated speed of the in vivo device during the time of capturing the images, or according to the similarity between consecutive images in the stream. For example, in an embodiment disclosed in U.S. Pat. No. 6,709,387, an image processor correlates at least two image frames to determine the extent of their similarity, and to generate a frame display rate correlated with said similarity, wherein said frame display rate is slower when said frames are generally different and faster when said frames are generally similar.

The image stream may be presented to the viewer by displaying multiple images in a plurality of windows, such that a set of consecutive or adjacent (e.g., next to each other in time, or in time of capture) frames may be displayed substantially simultaneously. According to one embodiment, in each time slot or period (e.g. a period in which one or more images is to be displayed in a window), a plurality of images which are consecutive in the image stream are displayed, one in each window or viewing area. The duration of the timeslots may be uniform for all timeslots, or variable. Across a series or sequence of consecutive time slots or periods, images or sets of images may be displayed.

In some embodiments, the image stream may be presented to the viewer by displaying multiple images in a plurality of windows, such that a set of consecutive or adjacent (e.g., next to each other in time) frames are displayed in an alternating manner. For example, instead of displaying a set of consecutive or adjacent frames substantially simultaneously during a single time slot, one or more images of the set may be displayed in windows on the monitor in a certain time period, and other images of the set may be displayed a predetermined time period after the initial images of the set. In this manner, the set of images may not be changed simultaneously and presented for a duration of a single time slot, but rather in an alternating order, for example according to a predetermined order of change that has been selected or programmed. Images from different adjacent sets of consecutive frames may be displayed simultaneously on the monitor. For example, in a display of eight windows on the monitor, four images from a first set of consecutive images may be displayed at time T₁ for a duration of one minute, and four images from a second set may be displayed at T₁+30 seconds, for a duration of one minute. The images from the first set may be replaced on the monitor by images from a third set at time T₁+60 seconds, such that images from the first set and the second set are displayed at partially overlapping time periods, and images from the second set and the third set are also displayed at partially overlapping time periods. For example, not all images need to be changed simultaneously and presented simultaneously in time slots for predetermined time durations. Different windows may change their displayed image at different times and/or rates, and may display the images for different durations of time (which may depend, for example, on a score or rating of the image).

In other embodiments, the display rate of the images in one or more windows of the plurality of windows on the monitor may vary. For example, a first display rate may be used for the main or primary window, and another display rate may be used for the peripheral windows. In some embodiments, the main window may display images at a predetermined rate R₁, and the peripheral windows may display images at a second rate R₂, which may be for example twice as fast as R₁. Such embodiment may be useful to present to the user images which are more important (e.g., “interesting” images such as images depicting anatomical landmarks or pathologies) in the main window, and images which are rated as less interesting may be displayed at a faster rate in the peripheral windows.

In an exemplary embodiment, the windows or viewing areas are allocated close together, with a minimum of blank or black space between the images, and typically horizontally and side by side, to allow a viewer to see the entirety of the images without substantially moving his eyes. The images may be warped (e.g., displayed in a cone, oval or ellipse shaped field) to further reduce the space between them. The images may be displayed with symmetry. For example, the images may be displayed in the same horizontal plane. One image may be reversed and presented as a mirror image, the images may have their orientation otherwise altered, or the images may be otherwise processed to increase symmetry.

The viewing time of the image stream may be reduced when a plurality of images are displayed simultaneously. For example, if two images are displayed simultaneously, and in each time slot a consecutive set of images is displayed (e.g., with no repeated images displayed across different time slots, such that each image is displayed in only one time slot), then the total viewing time of the image stream may be reduced to half of the actual time, or the duration of each time slot may be longer to enable the reviewer more time to scan the images on display. For example, if an original image stream may be displayed at 20 frames per second, two images displayed simultaneously in each time slot may be displayed at 10 frames per second. Therefore the same number of overall frames per second is displayed, but the user can view twice as much information and each frame is displayed twice as long. A trade-off exists between the total display time for the image stream and the duration that each image appears on display. For example, the total viewing time may be the same as that of the original image stream, but each frame is displayed to the user for a longer period of time. In another example, if a user is comfortably viewing a single displayed image at one rate, adding a second image will allow the user to increase the total review rate without reducing the time that each frame is displayed. In alternate embodiments, the relationship between the display rate when the image stream is displayed as one image stream and when it is displayed as multiple streams may differ; for example, the resulting multiple image streams may be displayed at the same rate as the original image stream.

In another example, the display method may not only reduce a total viewing time of the image stream, but also increase the duration of display time of some or all images on the screen.

In an exemplary embodiment, the user may switch modes, between viewing a single image and viewing multiple images, for example using a control such as a keystroke or on-screen button selected using a pointing device (e.g., mouse). The user may control the multiple image display in a manner similar to the control of a single image display, for example by using on screen controls. In an alternate embodiment, only one mode may be offered to the user.

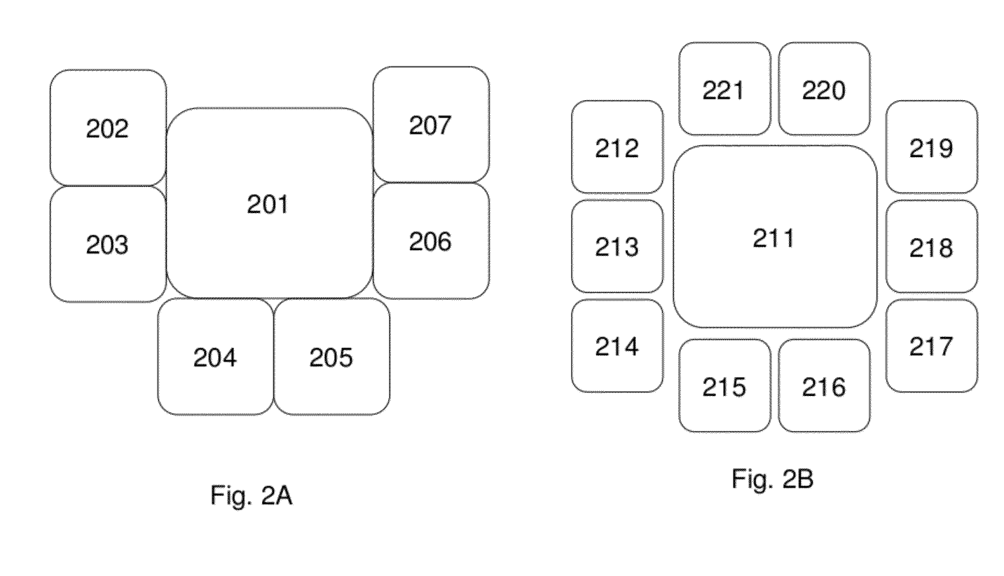

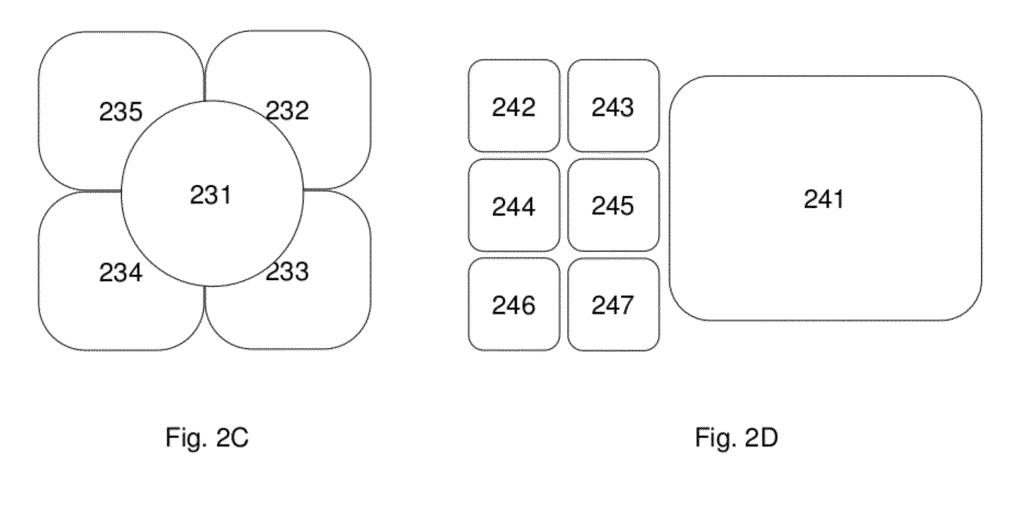

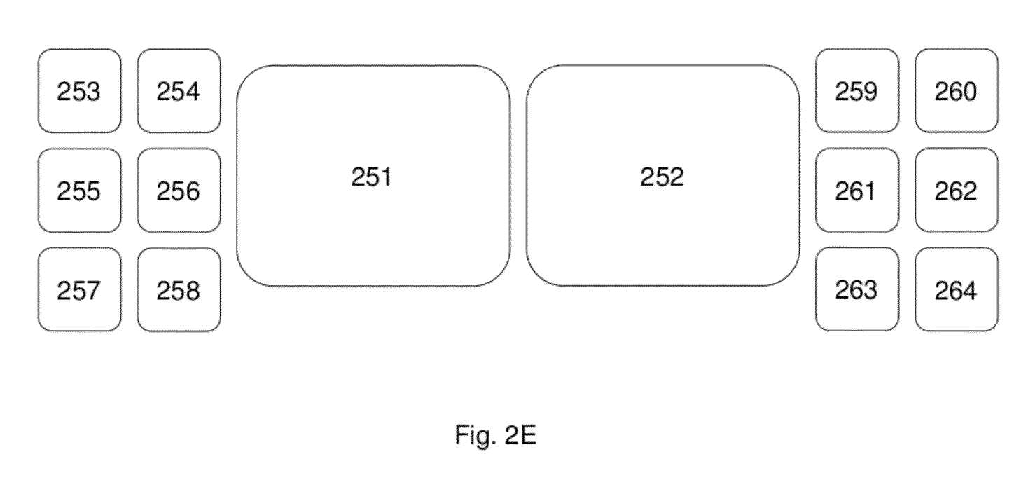

FIGS. 2A-2C depict a portion of displays according to an embodiment of the present invention. Referring to FIG. 2A, the display 200 is in multiple window display mode. The display 200 may be displayed on, for example, image monitor 18. The display 200 may include a set of, for example, seven in vivo image windows 201-207 for simultaneously displaying in vivo images captured in one or more streams, a color bar 208 indicating average color of images in the stream, and a set of controls 2009.

In some embodiments, a primary, central or main image window 201 may be a relatively large window displaying a stream of images. The main or central window 201 is typically larger than the peripheral windows 202-207. The main image window 201 is typically where the viewer focuses his/her attention during the review of the image stream. Different methods may be used to select images to be displayed substantially simultaneously on image monitor 18. With respect to each frame from the reduced image stream displayed in the main image window 201, a group of image frames may be selected for display concurrently with it in peripheral windows 202-207. These accompanying frames may be selected from the original image stream, but in some embodiments, the accompanying frames may be selected from the reduced image stream. Typically, a central, main or primary window or windows is located towards the center of a screen or viewing area, and a peripheral window or windows are located away from the center of a screen or viewing area. A central, main or primary window or windows may be partially or completely surrounded by peripheral windows. A main or primary window or windows may be larger than peripheral windows. A mix of these qualities may be used in various embodiments, or other qualities may differentiate a main window from a peripheral window.

Main image window 201 may include or be used to display only selected images from the original image stream, e.g. images from a reduced image stream. Peripheral image windows 202-207 may include or be used to display images from a reduced image stream as well, or may include images from the original image stream. The main image window 201, may include selected “interesting” or clinically relevant images from the complete (original) set of captured images, e.g. images which are suspected to include pathology or abnormality, images that are captured during fast motion of the imaging device, etc. The peripheral image windows 202-207 may display a combination of images from the reduced stream and from the original stream. While the reduced image stream is displayed in the main image window 201, the peripheral image windows 202-207 may display images from the reduced image stream which have already been previously displayed in the main image window 201, thereby providing longer total display time for the images from the reduced stream, which are considered more interesting or clinically relevant compared to images from the original image stream which were not selected for the reduced stream. Thus in each time slot one or more new images may be displayed and in addition, images that were displayed in previous time slots may be displayed again in different display windows. One or more images may be displayed repeatedly across consecutive time slots. In some embodiments, the peripheral image windows 202-207 may display images from the original image stream, for example images which were not selected for the reduced stream and were not displayed in the main or primary window. Viewing these images in peripheral windows may provide important additional information to the viewer.

Another benefit of the additional images displayed in the peripheral windows 202-207 is observable when a user stops (e.g., pauses) the displayed image stream in order to study a certain image. For example, if the stream is displayed using a fast frame display rate, by the time the user decides that he/she wants to inspect a specific image viewed in the main window, that image may have already disappeared from the main window, for example due to the delay between the eye and the hand's motion to click on the pause button. If the configuration of the display is such that the peripheral windows show the previous images, the specific image may reappear in one of the peripheral windows in a subsequent time slot. The user may have quick access to the wanted image. For example if the user locates the sought image in a peripheral window, by clicking on (e.g., using a pointing device such as a mouse) the peripheral window, the image may automatically be enlarged or presented in the main window.

In some embodiments, when a user stops or pauses the moving image stream display, different criteria may be used for determining which images to display during the pause period. For example, not necessarily all images displayed in the time slot during which the pause button was pressed may be displayed. Images which are considered more important for clinical review, or more interesting, e.g. likely to include pathologies or anatomical locations of interest, may be selected for display during the pause period. In one example, all images from the original image stream displayed in the peripheral windows may be replaced during the pause period by images from the reduced stream. In another example, only images which were previously displayed in the main or primary window may be displayed during the pause period in the peripheral windows. When the user continues to play the movie stream, the regular viewing criteria may be used again to determine the images for display.

For example, the user may select viewing a reduced stream mode, in which the reduced image stream displayed includes selected images from the original image stream. An image from the reduced stream may be displayed in the main image window 201, and images in the reduced stream, captured in time periods adjacent to the capture time of a current image in the main image window 201, may be displayed in the peripheral windows 202-207. In some embodiments, the adjacent images of the reduced stream may include subsequent images in the reduced stream. Images in the reduced stream may be sequentially numbered according to their chronological time of capture, for example, a portion of a reduced image stream may include thirty images sequentially numbered 91 to 120. In one embodiment, if image 100 of the reduced image stream is currently displayed in the main image window 201, image 101 may be displayed simultaneously or substantially simultaneously in peripheral window 202, image 102 may be displayed simultaneously or substantially simultaneously in peripheral window 203, etc. In other embodiments, the adjacent images displayed concurrently on the monitor may include preceding images of the reduced stream. For example, if image 100 is displayed in the main image window 201, image 99 may be displayed simultaneously or substantially simultaneously in peripheral window 202, image 98 may be displayed simultaneously or substantially simultaneously in peripheral window 203, etc. In yet other embodiments, a combination of preceding and subsequent images may be displayed. For example, if image 100 of the reduced image stream is displayed in the main image window 201, image 97 may be displayed in peripheral window 202, image 98 may be displayed in peripheral window 203, image 99 may be displayed in peripheral window 204, image 101 may be displayed in peripheral window 205, image 102 may be displayed in peripheral window 206, and 103 may be displayed in peripheral window 207. The set of consecutive images 97-103 of the reduced stream is displayed substantially simultaneously (e.g., in a single time slot), allowing the user to focus his/her attention or gaze onto the main image window 201, while simultaneously scanning the adjacent images in the peripheral windows 202-207.

In subsequent time slots, in some embodiments, the complete set of images displayed in peripheral windows 201-207 may be replaced or exchanged, and the user may view a new set of images which does not overlap with a first set of consecutive images viewed in the preceding time slot (e.g., the new set of images includes no images from the preceding time slot). For example, if images 97-103 were displayed in the first time slot, images 104-110 may be displayed in a second time slot, images 111-118 in a third time slot, etc. Thus in each time slot a different set of images is displayed on the monitor, and no image is displayed across consecutive time slots.

In other embodiments, the set of images displayed in one time slot may include images already viewed in the previous time slot or slots. For example, if images 97-103 were displayed in the one time slot, images 98-104 may be displayed in a subsequent time slot, 99-105 in the next time slot, etc. In other embodiments, different numbers of images may overlap (e.g., be repeatedly displayed) across two subsequent time slots (e.g., if images 97-103 were displayed in one time slot, images 100-106 may be displayed in the subsequent time slot). The number of overlapping (e.g., repeated) images in adjacent time slots may be determined, for example, by the degree of similarity between the set of images to be displayed in the upcoming time slot. In some embodiments, a default mode of reduced stream viewing may include no overlapping or repeated of images across consecutive time slots.

In some embodiments, the display method may ensure that all images of the original set of images are displayed on the monitor. For example, the main or central window/s may include images from a reduced set, and the peripheral windows may include images from the original set, e.g. only images from the original set which have not been selected for the reduced set. In some embodiments, different display methods may be used with different window arrangements on the screen, and display methods may be combined.

Different considerations or criteria may be used to determine the set of images to be displayed substantially simultaneously during a single time slot. In one embodiment, the display method may include displaying images from a single image stream, e.g. a reduced stream or an original stream. In some embodiments, images displayed in one time slot may be repeated in the next time slot, for example in different display windows. Other embodiments may not include repeated images in subsequent time slots, e.g., each image may be displayed in a single time slot during the movie.

In another embodiment, the main or primary window may display images from a first stream, and the peripheral windows may display images from a different stream or from a plurality of different streams.

In yet another embodiment, images from a first stream may be displayed the main image window, and a combination of images from several streams (including the first stream) may be displayed in the peripheral windows.

Different considerations or criteria may be used to determine whether to repeat an image in a subsequent time slot. These considerations may be combined with different display methods which may determine the set of images to be displayed simultaneously, and/or the sequence of images for display. The degree of similarity between images may be one of the considered criteria. For example, if the degree of similarity between images displayed simultaneously in one time slot is low, it may be useful to repeat some of the set of images in the subsequent time slot and therefore allow the user to review these images again before continuing to the next set of images. The degree of similarity may be scored or rated (e.g., using image similarity detector 24), and based on the score, the number of images that should be repeated in the next time slot may be determined. A similarity threshold score may be set in order to determine which images to repeat.

In another example, the decision whether or not to repeat a specific image in a subsequent time slot, or whether to display an additional image from the original image stream (not selected for the reduced stream), may be based on the amount of content or turbid content (e.g., intestinal fluids, contents, bubbles, etc.) which may be found in the image (e.g., using content detector 22). If an image is considered very “dirty”, e.g. unclear, or receives a high score or rating of the content detector 22, the image may not be displayed again, or may not be displayed at all. Similarly, the quality of the image may also be considered in the decision to display an image. For example, illumination quality of the image may be analyzed, for example by processor 14, and images of low illumination quality, e.g. images which are oversaturated or very dark, may not be selected for display, in order to provide clear and clinically valuable images to the reviewer. Other criteria may be used in order to rate or determine which images are more valuable and should be presented to the user, and which images are less valuable for display.

In some embodiments, while the user is viewing a reduced stream mode, the images displayed simultaneously in peripheral windows 202-207 may include images from the original image stream, e.g., from a subset of images of the original image stream which were not selected for the reduced stream. In one embodiment, the subset of images not selected for the reduced stream may be obtained by subtracting the set of images selected for the reduced stream from the set of images of the original image stream. For example, if the set of consecutive images in the reduced image stream for display in a single time slot includes images that largely differ from each other, it may be useful to display an image from the reduced stream in the main image window 201, and simultaneously display in peripheral windows 202-207, adjacent or substantially adjacent images from the obtained subset of images (the images not selected for the reduced stream). For example, images displayed from the obtained subset of images may include images captured in an adjacent time period to the capture time of the selected image in the reduced stream, and which were not selected for the reduced stream. Images captured in an adjacent time period may include, for example, images captured a predetermined time duration before or after the time of capture of the image from the reduced stream displayed in main or primary window 201 (e.g., up to 60 seconds before or after).

In some embodiments, the degree of similarity between images from the original image stream may be similar to or higher than the degree of similarity between adjacent images in a reduced image stream, therefore when displaying simultaneously (in the same time slot) images from the original image stream in the peripheral windows 202-207 surrounding the main image window 201, the user may receive additional information which may assist in accomplishing a more thorough review of the reduced image stream.

In one embodiment, the selection of images from the original image stream for display in the peripheral windows may be performed according to the image capture times. For example, the time gaps between consecutive images captured in the original image stream may be 0.03-0.5 seconds (e.g., in frame capture rates of 2 frames per second to 30 frames per second). In the reduced stream, however, the capture time gaps between consecutive images may be very long, depending on the selection criteria of the reduced set of images. A time-based threshold or time window may be determined, for example a Maximum Time Threshold of 60 seconds between capture times of images which are to be displayed within the same time slot. When an image from the reduced stream is displayed in the main window, the time duration or time gap between the capture times of the adjacent images in the reduced stream may be calculated. In some embodiments, if the time duration is larger than the Maximum Time Threshold, an image from the original stream which was captured in an adjacent time period to the image displayed in the main window (e.g. has a time difference from the main image not larger than the maximum threshold duration), may be inserted to the display, and may replace a different image in the current time slot in order to maintain a smooth flow or continuity of the image stream. It may be advantageous to present a continuous movie or image stream or a substantially continuous movie or image stream, in order to allow the viewer to focus on important features or changes that appear in the content of the images, and not be distracted by substantial differences from one image to the next (e.g., if the movie is not continuous). In some embodiments, the threshold may be calculated based on a number of frames captured in the original image stream during the time duration between capturing of adjacent images in the reduced stream. For example, a maximum number of 100 images (in the original image stream) between images subsequently displayed in main image window 201, or between images selected in the reduced image stream, may be determined as a Maximum Number of Frames Threshold. If the number of frames captured in the original image stream during the time period between the capture time of two adjacent images in the reduced stream, exceeds the Maximum Number of Frames Threshold, additional images from the original image stream (for example, captured during the time period between the capture time of two adjacent images in the reduced stream) may be inserted in the peripheral windows, enhancing or complementing the reduced stream. The additional images from the original image stream may replace images from the reduced stream, which may be displayed, for example, in a next time slot.

In some embodiments, if the number of images available for display in peripheral windows 202-207 during the next time slot is smaller than, or equal to, the number of images in the original image stream captured within a certain time duration (e.g. based on the Maximum Time Threshold or the Maximum Number of Frames Threshold), all images from the original stream captured within that time duration may be displayed, and some images from the reduced stream may be repeated. If the number of images available for display in the next time slot is larger than the number of images in the original image stream captured during the predetermined time duration, a selection of images from the original image stream may be performed according to predetermined selection criteria, for example according to one or more scores which may be associated with the images. A selection of images from the original image stream may be performed in order to determine which images should be added to the peripheral windows. For example, low quality images (e.g. images with a relatively high percentage of turbid content, blurred images or over-saturated images), may not be selected for display.

In some embodiments, in cases of fast movement of the imaging device, more images may be selected from the original image stream for display in the peripheral windows, in order to complement the images selected in the reduced stream. Generally, when the imaging device is moving at a fast speed, more images may be displayed in the main window. When the imaging device is moving slowly or relatively slowly, images displayed in the main window may be repeated in the peripheral windows, for example in subsequent time slots.

A user viewing multiple images simultaneously may direct the center of his vision to a central point on the screen. The user may absorb the relevant information about the images in such a manner; such viewing may require a period of training. For example, if the images are in vivo images of the GI tract, the user may, by directing his gaze to main image window 201, absorb information regarding pathologies from the set of image windows 202-207.

In FIG. 2B, another configuration of the in vivo image windows displayed simultaneously is shown. Similarly to embodiments described in FIG. 2A, main image window 211 may typically be larger than the peripheral windows 212-221. main image window 211 may display an in vivo image from a reduced or edited image stream, while windows 212-221 may, concurrently with the display of the central, main or primary image, display peripheral images which may be extracted from the original image stream and/or from the reduced or edited image stream. The configuration of the display may include, for example, ten image windows surrounding the main image window. The peripheral windows may be substantially adjacent to the main image window, as shown in FIGS. 2A and 2C, however in some embodiments the peripheral image windows may be distanced from the central window, or may have blank, black or otherwise colored or patterned spaces between adjacent or neighboring windows. The peripheral images displayed in windows 212-221 concurrently or in the same time slot with the central image in window 211 may include subsequent images from the reduced stream and/or from the original stream, preceding images from the reduced stream and/or from the original stream, or a combination of preceding and subsequent images. The images displayed concurrently in a single time slot may be displayed again in the next time slot, or may be replaced by new images. A decision whether to display the same images again in the next time slot may be taken based on an estimated speed of the in vivo device during the time of capturing these images, or based on a similarity measurement or the degree of similarity or difference between the images, or based on other image parameters, for example if an image is detected by a pathology detector as suspected to include pathology, the image may be displayed again in the next time slot. A reduced/original image stream differentiation need not be used in some embodiments.

Upon making decision (e.g., via a processor such as processor 14) that an image should be repeated in the next or following time slot (e.g., there is partial overlap between the set of images displayed in a current time slot and the set of images displayed in the subsequent time slot), the position of the image in the display windows may be determined (again, for example by data processor 14). For example, in a current time slot T₁, images 100-110 from a reduced image stream may be displayed (e.g. in FIG. 2B central, main or primary window 211 may display image 110, and windows 212-221 may display images 100-109). Data processor 14 may determine that the degree of similarity between images 105-110 is very low, e.g. below a certain threshold, or may estimate that the speed of the in vivo device during the time of capturing the images may be relatively fast. Therefore, a decision may be taken to repeat the display of images 105-110 in the next time slot T₂, allowing a health professional reviewing the image stream more time to review the portion of the steam that changes rapidly. In time slot T₂, image 115 may be displayed in central window 211, and images 105-114 may be displayed substantially simultaneously in peripheral windows 212-221.

In FIG. 2C, a different window configuration of in vivo images displayed simultaneously is shown. Central window 231 may have a different shape than the peripheral windows 232-235. In some embodiments, the images may be fused or partially merged in the bordering areas between the windows, for example along the outline of central window 231, in order to make the display more uniform or homogeneous to the reviewer's eye. Examples of fusing images can be found, for example, in embodiments described in U.S. Pat. No. 7,474,327, assigned to the common assignee of the present invention and incorporated herein by reference. In some embodiments, images may be deformed to different shapes. For example the image displayed in central window 231 may be deformed to a circular shape, while peripheral images 232-235 may be deformed to another shape.

In FIG. 2D, another optional configuration of image display is illustrated. Central window 241 may display a more important or clinically valuable image, e.g. an image from the reduced stream, while the additional image windows 242-247 may display previous (or next) images from the reduced stream (e.g. which may be repeated in subsequent time slots) and/or added images from the original image stream.

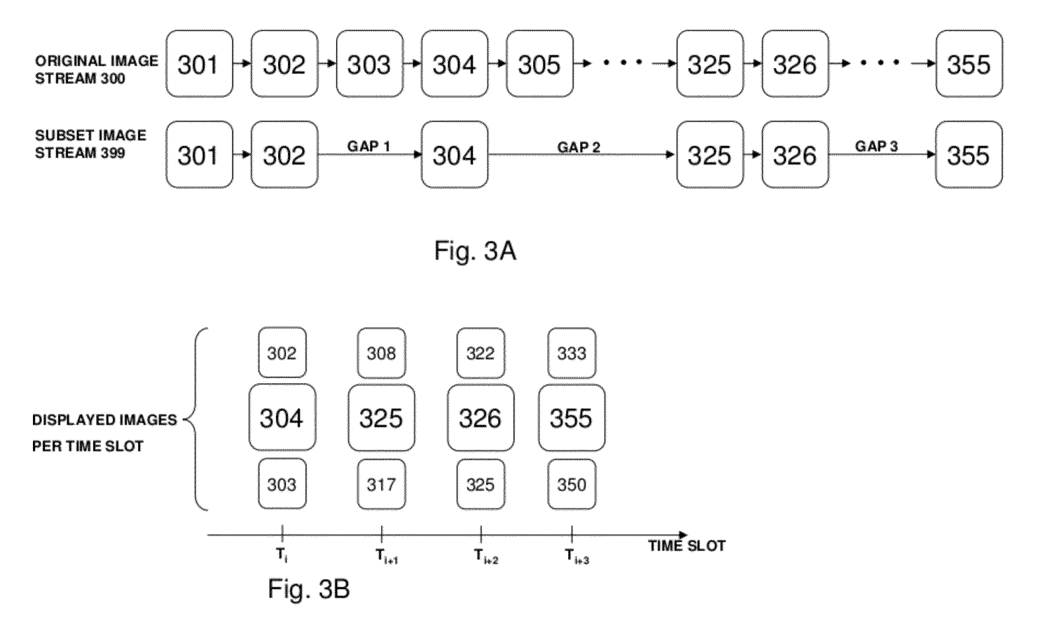

In certain embodiments of the present invention, more than one image stream may be collected. For example, an in-vivo vehicle may include one imager 46 (or more) collecting multiple image streams. According to one embodiment, the in vivo vehicle may comprise an imager or lens system in more than one location on the vehicle. In the case of a capsule 40, multiple imagers 46 may be arranged, for example, a double-headed imaging capsule may include two imaging systems, one at either end of the capsule 40, or at the same end of the capsule, in different positions or different angles. A capsule which includes a plurality of imagers is described, for example, in the embodiments of FIGS. 2 and 3 of U.S. patent application Ser. No. 11/603,123 to Gilad et al., which is assigned to the common assignee of the present application and incorporated herein by reference. Each imager 46 may capture images and transmit the images via the transmitter 41 or via separate transmitters. Typically, each imager 46 has an associated optical system. Such capsule, for example, may be the PillCam® ESO2 capsule manufactured by Given Imaging, Ltd. of Yoqneam, Israel. In such a case, an embodiment of the system and method of the present invention may display a plurality of image streams simultaneously. Images displayed simultaneously on the viewer screen may be images captured during a single time period, by one or more of the plurality of imagers 46. In one embodiment, one or more images from each of the imagers 46 may be displayed substantially simultaneously so that image streams from different imagers may be reviewed simultaneously. In some embodiments, a reduced image stream may include images captured by a single imager, generating a plurality of reduced streams which may be displayed simultaneously. In another embodiment, the reduced image stream may include images captured by any imager of the in vivo device, so that a single reduced stream of the in vivo imaging procedure may be generated and displayed. An exemplary configuration of multiple windows for two imaging systems is illustrated in FIG. 2E.

Two main, primary or central windows 251 and 252 may display images captured by different imaging heads in the reduced image stream, for example images displayed in window 251 may be captured by a first imaging head, and images displayed in window 252 may be captured by a second imaging head. The peripheral windows 253-258 may include images from the reduced stream or original stream, captured by the first head, while peripheral windows 259-264 may include images from the reduced stream or original stream, captured by the second imaging head.

In some embodiments, images displayed in the peripheral windows may be ordered chronologically, according to the time of capture of each image. In other embodiments, images displayed in the peripheral windows may be ordered according to other criteria, for example: similarity between the displayed images, pathology scores or ratings, or other ordering criteria. A user may select a certain order configuration from a selection list which may be provided in a user interface. For example, the images may be displayed in a reverse chronological order, e.g., the last images captured may be displayed first, going backwards chronologically as the movie progresses. In such configuration, the forward and backward play buttons skip images according to the reverse chronological order instead of the normal order of image capture.

Reference is now made to FIG. 3A, which schematically illustrates a segment of an original image stream 300 including image numbered 301-355, and a segment of a corresponding reduced image stream 399 according to an embodiment of the present invention, and FIG. 3B, which illustrates images displayed in consecutive time slots. The original image stream segment 300 may include, for example, all images captured by the in vivo device, e.g. images 301-355. The subset of images (reduced image stream segment 399), may include a portion of the images from the original set, e.g. images 301, 302, 304, 325, 326 and 355, selected according to one or more criteria or conditions. Gaps in the reduced stream are indicated in time periods during which unselected images of the original stream were captured. For example, the subset of images may include images with clinical value, such as images that resemble similarity to a pathology reference image. In some embodiments, the subset of images 399 may include images which have a high level of red color, which may indicate suspected bleeding in the imaged organ. Other criteria may be used instead of, or in addition to these examples, for selection of the subset of images 399 from the original image stream 300.

When displaying the reduced image stream 399, multiple images may be displayed according to different window arrangements, for example according to the window arrangement shown in FIG. 3B, or according to one of the configurations shown in FIGS. 2A-2E, or using other screen configurations or combinations thereof. One or more criteria or scores may be calculated in order to determine which images to display simultaneously on the screen, in the peripheral windows located along the central window.

In FIG. 3B an exemplary display of a large main image window and two smaller peripheral image windows is illustrated. The central window may display the images from reduced stream 399, and the peripheral windows may display images from the original image stream 300, which were not selected for the reduced stream 399, or may repeat images from the reduced stream 399. In one embodiment, the main image window may display the current image, and the peripheral windows may display previous images from original stream 300 or from reduced stream 399. In time slot Tᵢ, the central window may display the image 304 from the reduced stream, and image 302 may be repeated in a peripheral window in this time slot (for example, image 302 may have been previously displayed in a main window, for example in timeslot Tᵢ₋₁). The other peripheral window may include image 303 which was not selected for reduced stream 399, and was not displayed in previous time slots. In time slot Tᵢ₊₁, the next image 325 from reduced stream 399 is displayed in the central window, while images 308 and 317 from original stream 300 are selected for display in the peripheral windows. Other arrangements are possible, and different screen configurations or number of images displayed concurrently may be selected.

The criteria for selecting which images to display in the peripheral windows (simultaneously with the main image) may be based on similarity between adjacent images. For example, if images of a first group 302-314 are substantially similar to each other, or their degree of similarity is above a certain threshold, and images of a second group 315-324 are substantially similar to each other, then a representative image from each group of similar images may be selected for display simultaneously or substantially simultaneously, e.g. images 308 and 317. In some embodiments, one or more scores used for determining which images are selected for the reduced stream 399 may also be used for determining which images will be displayed in the peripheral windows.

According to one embodiment, in each time slot, based on one or more of the degree of similarity between displayed images or between adjacent images in the original image stream or the reduced image stream, estimated speed of the capsule (e.g. if the speed is known or estimated by using an accelerometer or other location sensor of the capsule's position in space), relative importance of the image or other scores or ratings which may be calculated by a processor based on image criteria, a decision may be made whether to repeat an image in the next time slot, or to advance the image stream forward by displaying the next images.

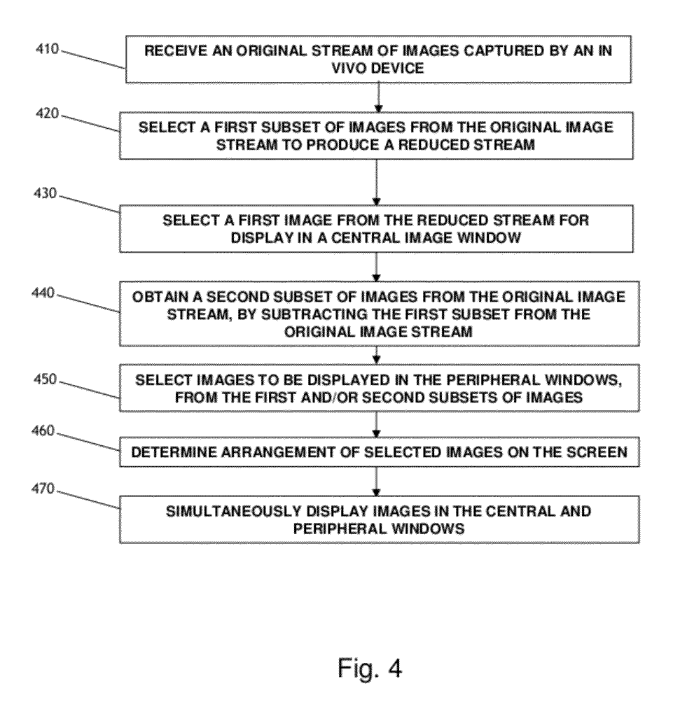

Reference is now made to FIG. 4, which includes a flowchart depicting a method for displaying an image stream according to an embodiment of the invention. In operation 410, an original stream of images may be received, for example transmitted from an in-vivo device such as a swallowable capsule that traverses the gastrointestinal tract (or the stream may be created from received images). The original stream may then be reduced or edited, according to a first selection method, which may be comprised of one or more selection criteria, and a first subset of the original set of images may be selected for display in operation 420. The original image stream may be generated e.g., in a workstation, or another device, from images received from an in-vivo device.

In operation 430, a first image from the reduced stream (first subset) may be selected for display in a main image window. A screen configuration of multiple image windows may be preset or selected by a user. The configuration of the image windows on the display may include one or more main image windows, and a plurality of peripheral image windows, which are typically smaller in size compared to the main image window(s). The image displayed in the central window(s) may be selected according to chronological order of the capture time of the images in the reduced stream, or according to a different order or priority (e.g. the images may be re-ordered based on pathology detection scores assigned by the pathology detector 23, similarity scores assigned by image similarity detector 24, content detection scores assigned by the content detector 22, etc.).

In operation 440, a second subset of images may be obtained from the original image stream. The second subset may be created or calculated, for example, by subtracting the first subset of images (selected for the reduced stream) from the original stream of images. The resulting second subset of images includes all images not selected for the reduced stream.

In operation 450, the images to be displayed in the peripheral windows, simultaneously with the selected central image, may be selected according to a second selection method. The peripheral images may be selected from the original stream and/or from the reduced stream, and a combination of different criteria may be used to determine which images should be displayed. For example, images for display in the peripheral windows may be selected according to their time of capture, captured a predetermined time period before or after the time of capture in the original image stream of the selected central image. In another example, the peripheral images may include images which are representative images from groups of sequential images which were captured, for example, chronologically before or after the image selected for display in the main or central window. Images which are captured sequentially may be very similar, and a single representative image may contain substantially all the information which was captured in a plurality of sequential images in the original image stream.

The peripheral images may provide to the viewer additional data or information, which may not be present in the central image, thereby enhancing the central image and making the user's review more efficient. In some embodiments, a combination of selection criteria or methods may be used to select the images for display in the peripheral windows, and/or in the central window. In some embodiments, different criteria may be used to determine which image of the set of concurrently displayed images will be displayed in the main image window. For example, images may be scored or rated according to different criteria, which may include their estimated “importance.” An image suspected to include pathology may be clinically more important than images not including pathology, and therefore may be selected as the central image displayed. In some embodiments, images which were captured during fast movement of the in vivo device (or the tissue walls, which may also move), may be more important than images captured when the in vivo device is substantially stationary. Other criteria may be used for rating the images, and the image (from the set of images to be displayed concurrently) which received the highest score or rating or highest combined score if more than one score is used, may be positioned in the central window.

In some embodiments, one or more images from the second subset of images selected for display in a certain time slot are, in the order of the original image stream, a predetermined number of images before or after the first image which is displayed in the central window in the same time slot. The images from the second subset of images displayed in the peripheral windows in a certain time slot may have been captured a predetermined number of images before or after the capture of the centrally displayed image in the order of the original image stream.

In some embodiments, images from the reduced stream may be repeated in more than one consecutive time slot. For example, a degree of similarity between images in the subset of images may be determined. For example, the degree of similarity may be scored or rated using a scale, such as 0-10, wherein a score of ‘0’ may indicate no similarity between the images, and a score of ‘10’ may indicate the images are substantially identical to each other. In one embodiment, images which are consecutive or adjacent to each other in the reduced stream may be compared, and the degree of similarity may be determined and stored for these images. In another embodiment, the comparison may be performed for all images which are to be displayed in a single time slot (simultaneously), in order to determine whether it is required to repeat a portion of the images in a next time slot, and/or to add images from the original image stream. In some embodiments, the degree of similarity may only be determined for pairs of adjacent images in the reduced stream (e.g., if images 100-110 of a reduced stream are to be displayed, the comparison may be determined for the pair of images 99 and 100, 100 and 101, 101 and 102, etc.). In other embodiments, the degree of similarity may be determined for more than a pair of successive or consecutive images.

The degree of similarity between the selected images may be compared to one or more thresholds, which may be used for determining how to display images. For example, if the degree of similarity between a pair of images is above a first threshold, the pair of images may be determined to be displayed only in one time slot, adjacent to each other. If the similarity score between another pair of images is between the first threshold and a second threshold, the images may be repeated in the next time slot. In some embodiments, only one image of the pair may be repeated in the next time slot. For example, if images 104 and 105 are similar, but images 105 and 106 are very different, some embodiments may repeat image 106 may in the next time slot. In other embodiments, both images of the pair may be repeated.

A threshold may be set for padding the displayed images with additional images from the original image stream, e.g. displaying images from the second subset of images, which have not been selected for the reduced stream. If the degree of similarity between a specific pair of images is below the threshold, one or more images from the original image stream may be added to the display. The added image is preferably an image captured during the time of capture of the specific pair or between the times of capture of the two images, e.g. after the first image of the pair was captured and before the second was captured. In such a case, the additional image will be displayed concurrently with the pair of images, and one of the new images selected for display from the reduced image stream (for example, the image captured latest from the selected images) will be delayed to a later (next) time slot. Adding extra images from the original stream to the displayed images may increase the efficiency of the professional review, since more information of the tissue during the in vivo device's passage in periods of fast movement may be provided to the reviewer. In some embodiments, images may not be repeatedly displayed in more than one time slot. In other embodiments, images may be repeated in two or more consecutive time slots.

In some embodiments, the number of available image windows on the screen in a timeslot may be determined. For example, if the display configuration includes a main image window and seven surrounding (peripheral) image windows, the number of available image windows in the next timeslot may be eight. However, if some of the images in the current timeslot are to be repeated in the next time slot, the number of available image windows may be less than eight.

In operation 460, the arrangement of the images to be displayed simultaneously on the screen may be determined. In one embodiment, the configuration of the images on the screen is predetermined, for example selected by a user according to personal preference. The configuration of the images may include a large main image window, and surrounding or peripheral image windows arranged substantially or partially around it. In one embodiment, the image displayed in the central window may be an image from the reduced stream, while images displayed in the peripheral windows may include images from the reduced stream and/or images from the original stream.

In an exemplary embodiment, the windows or viewing areas are close together, with a minimum of blank or black space between the images, and are typically horizontally and side by side, to allow a viewer to see the entirety of the images without substantially moving his eyes. The images may be warped (e.g., displayed in a cone, oval or ellipse shaped field) to further reduce the space between them. The images may be displayed with symmetry. For example, the images may be displayed in the same horizontal plane. One image may be reversed and presented as a mirror image, the images may have their orientation otherwise altered, or the images may be otherwise processed to increase symmetry. Typically, a tool available to the user which manipulates an image (e.g., region of interest or zoom) will have an identical effect on all images simultaneously displayed. Each image may be displayed with different post-processing. For example, one image may be subject to certain filtering or manipulation (e.g., red or green filtering, contrast enhancement, brightness alteration) and the other image may be subject to different or no filtering or manipulation.

In one embodiment, two or more images displayed substantially simultaneously may be fused together and displayed as a single entity. As such, a user may comfortably and concurrently incorporate information shown in each of the images while avoiding the distraction caused by the typically sharp contrast between connecting edges or between the images and the background color which may appear between the images when the images are spaced apart.

In operation 470, the selected images are displayed substantially simultaneously in a central window and peripheral windows, according to the determined arrangement, typically for observing and/or analyzing, for example, for detecting pathologies in the GI tract.

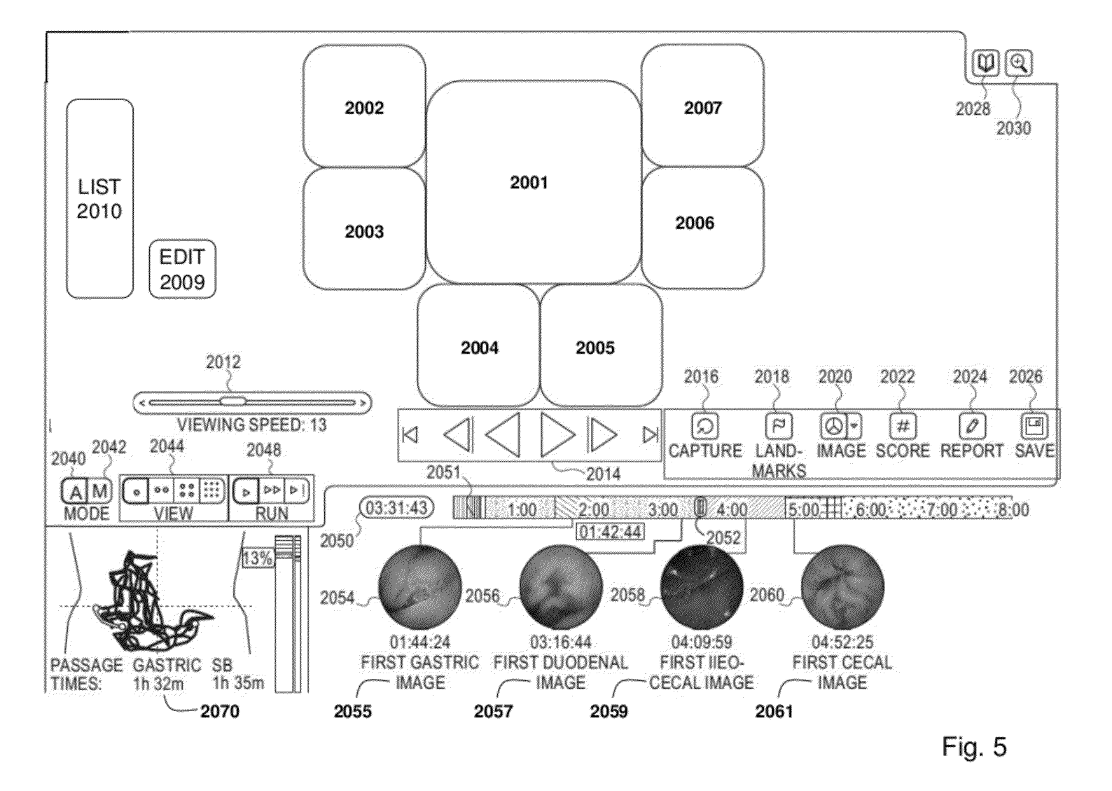

Reference is now made to FIG. 5, which schematically illustrates a graphical user interface (GUI) with a set of editing tools which may be displayed on a monitor, such as the monitor 18 of FIG. 1, according to an embodiment of the present invention. A main image window 2001 may display an image stream, such as a reduced image stream which contains a selected subset of images, or an original (e.g., unedited) image stream. In some embodiments, images may be displayed as a set of reduced-size images, e.g. thumbnails or larger images, and not necessarily as an image stream.

Controls 2014 may alter the display of the image stream in one or more image windows 2001-2007. Controls 2014 may include for example stop, play, pause, capture image, step, fast-forward, rewind, or other controls, to freeze, speed up, or reverse the image stream in window 2001-2007. An edit control 2009 may allow a user to select and set criteria, for example, from a list of a plurality of available criteria listed in chart 2010 (for example, by clicking a tab, check-box, or marker indicating specific criteria). The user may operate controls 2014 and/or edit control 2009 using an input device (e.g., input device 24 of FIG. 1).

In one embodiment, estimated properties of an edited image stream associated with the specific criteria selected in chart 2010 may be displayed, including, for example, an estimated movie duration (e.g., using a standard, average or predetermined frame rate for display), number of image frames, average estimated pathology detection accuracy, etc. The properties may be displayed for the image stream, or in some cases per image frame 2001, 2002, etc. In one example, the estimated pathology detection accuracy per image may be displayed, whenever the user freezes the image stream to view a single image or a set of images. The user may switch or adjust the selected criteria in chart 2010 until the desired properties are activated in the edited stream and displayed on the monitor. In another embodiment, chart 2010 may list different modes of optimal combinations of criteria, which provide for example the most accurate pathology detection, the shortest and/or longest viewing time, and/or the largest and smallest number of image frames, respectively. Accordingly, the user may select the desired mode to generate the corresponding edited movie.

According to some embodiments of the present invention, when one or more pre-defined criteria are selected from list 2010, edit control 2009 may activate the corresponding filter (e.g., editing filter 22 of FIG. 1) to generate an edited image stream based on the pre-defined editing criteria. Controls 2014 may then be used to control the display of the edited image stream in windows 2001-2007, for example, enabling image freeze, fast forward, rewind options, etc. For example, if a suspected blood indicator (SBI) criterion and large polyp criterion are selected in list 2010, an edited image stream in main window 2001 may be displayed with images frames having a combined SBI and large polyp score above a predetermined threshold. In other embodiments, a pre-designated (e.g. factory-set) combination of filters may be used on all image streams, or image streams selected for, e.g., a reduced-view display, by a user (e.g., one package of combinations is available to a user).

According to one embodiment of the invention, the user may combine or switch from one set of editing criteria to another while data is being streamed. A message window announcing/confirming the switch may be prompted, and the area and time frame of the resulting images may be displayed together with all relevant details pertaining to the selected editing system.

In some embodiments, the user may not be able to change the editing method, and a predetermined editing scheme or method may be pre-configured to produce an edited image stream or an edited subset of images. For example, the predetermined editing scheme may be based on the type of procedure that the patient underwent. A specific editing method may be used for a small bowel procedure, while a different method may be used for a colon procedure. The type of procedure may be determined according to the capsule type and/or may be input during the initialization of the procedure.

According to some embodiments, the edited subset of images may be displayed as an edited image stream, and/or as a set of frames on the display monitor, for example a plurality of frames of reduced size may be displayed. In some embodiments, more than one image stream may be displayed concurrently on the monitor, for example as disclosed in FIGS. 9A, 9B and 10A, 10B of U.S. Pat. No. 7,474,327 to Davidson et al., assigned to the common assignee of the present application and incorporated herein by reference in its entirety.

Timeline window 2051 provides a timeline or time chart of the image stream. Thumbnail images 2054, 2056, 2058 and 2060 may be displayed with reference to the appropriate relative time on the time chart 2051 based on the selected editing method. Related annotations or summaries 2055, 2057, 2059 and 2061 may include the image capture time for each thumbnail image, and summary information associated with the current thumbnail image, or with one or more of a plurality of pre-defined criteria used to edit the current frame displayed or frame indicated in the time chart 2051. Time indicator 2050 may provide a representation of the absolute time elapsed for or associated with the current image being shown, the total length of the edited image stream and/or the original unedited image stream. Absolute time elapsed for the current image being shown may be, for example, the amount of time that elapsed between the moment the imaging device (e.g., capsule 40 of FIG. 1) was first activated or an image receiver (e.g., image receiver 12 of FIG. 1) started receiving transmission from the imaging device and the moment that the current image being displayed was captured or received. Multiple monitors or image windows 2001-2007 may be used to display the image stream and other data.

Capsule position window 2070 may include a current position and/or orientation of the imaging device in the gastrointestinal tract of the patient, and may display different segments of the GI tract is different colors. A highlighted segment may indicate the position of the imaging device when the currently displayed image (or plurality of images) was captured. A bar or chart in window 2070 may indicate the total path length travelled by the imaging device, and may provide an estimation or calculation of the percentage of the path travelled at the time the presently displayed image was captured.

Buttons 2040 and 2042 may allow the viewer to select between a manual viewing mode, for example an unedited image stream, and an automatically edited viewing mode, in which the user may view only a subset of images from the stream edited according to predetermined criteria. View buttons 2044 allow the viewer to select between viewing the image stream in a single window, or viewing multiple image streams in double, quadruple, or mosaic view mode. The display buttons 2048 may display to the viewer images from the original stream, or only selected images with suspected bleeding indications.

Viewing speed bar 2012 may be adjusted by the user, for example the slider may indicate the number of displayed frames per second. Buttons 2016, 2018, 2020, 2022, 2024, and 2026 may allow a user to capture landmark images or thumbnail images, input a manual score or comment for an image, generate a report for the viewed image stream, and save the clinical findings and markings of the viewer.

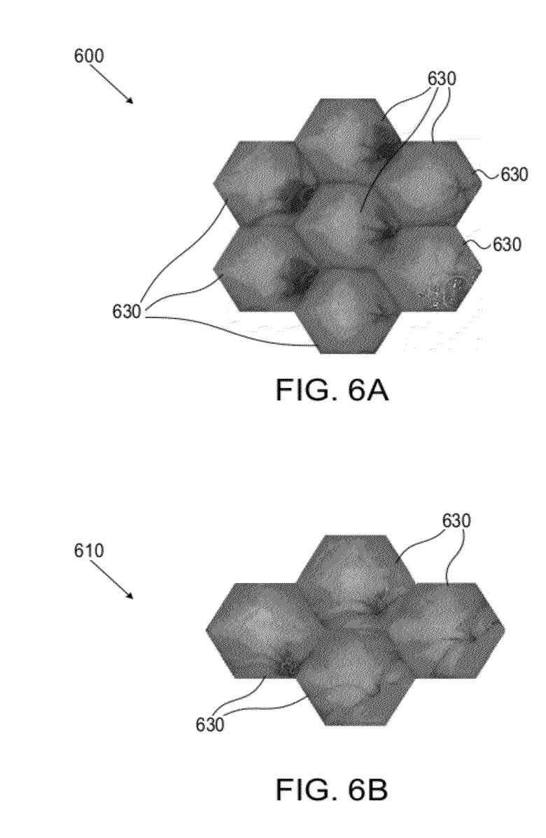

FIGS. 6A and 6B are views of user displays according to an embodiment of the present invention.

In FIGS. 6A and 6B, image portions or in-vivo images 630 are displayed to a user (e.g., on monitor 18) as one or more groups, collages, or arrangements such as groups 600 and 610 of hexagons, in this example touching one-another. While in the embodiments shown in FIG. 6 a certain number and arrangement of hexagons is shown, in other embodiments other arrangements and numbers may be used. The hexagons may be oriented differently than as shown. The groups 600 and 610 may be displayed as image streams. For example, a series of groups of hexagons may be displayed serially in the same position, as an image stream or movie is displayed, the difference being that multiple images are displayed in each time period, rather than one image per time period. A main image window and/or peripheral images may be displayed, as for example shown in FIGS. 2A-2C and other figures herein. For example, in group or arrangement 600, the hexagon at the central window may display a main or primary image, and the six surrounding or peripheral windows may display other images. In various embodiments, if peripheral windows are used, the peripheral windows may be hexagonal shaped, and/or a main image window may be hexagonal shaped.

In other embodiments the windows or hexagons need not touch, or borders can be used. In one embodiment, one image frame or image, or portion thereof, is displayed per hexagon.

In one embodiment, images originally produced by the optical system of an imager such as device 40 (or at least the useful or illuminated portions) are generally created in a first shape, e.g. a round shape (e.g., within a square border). An image or image portion which is initially round, may be re-shaped and displayed in a second image shape, e.g. as a hexagon or in a hexagon-shaped window or portion. Display of images in a hexagon shape may allow less distorting, stretching or shrinking of the original round image data, or less of the original round image data to be removed or cut off when fitting to a hexagon shape than, for example, if the image is reshaped to a square shaped display. Hexagon shaped images may nest or fit together in a multi-window display better than circular images, and hexagons can be tiled so that the area of the screen or display is used more efficiently. If the images are distorted to take up the full area of a window or shape, using a hexagon as such a shape may allow for less distortion of the original image than when using a square shape or image. In some embodiments, distortion of a round image to a square shape may result in distortion around the corners of the new square image patch, such that the edges between adjacent patches are more distinct during the viewing of the screen, and transitions from one neighboring image to another, are less smooth.

In order to fit a round image to or within a hexagon, outer areas of the image can be cropped or cut off, or the round image can be warped or distorted (e.g., using distortion-minimizing mapping) into a hexagon shape. For example, the largest possible hexagon can be applied to the image, removing image pixels outside the hexagon. A combination of these techniques can be used. In a preferred embodiment warping or distortion is used instead of cropping so that no data is lost.

In one embodiment, in order to capture a wide angle of view, a typical image captured by an imaging device includes an interior round shaped portion which contains useful information, termed a valid mask, surrounded by a dark or otherwise not useful portion (extending from the inner round portion to a typically square or rectangular border). The outermost portion, outside the valid mask, may be discarded. Reducing dark areas in the periphery in images may result in a smoother or more continuous collage or assembly of images, and smoother transitions between neighboring images (e.g., due to the lack or reduction of black borders due to dim lighting).

Outer portions of an image may be less useful for example due to the vignetting effect, a decrease in light or illumination towards the outer portion of the field of view.

In one embodiment, conformal mapping may be used to warp, distort or conform the round image to the hexagonal window or frame. Conformal mapping may be computationally intensive, and thus in some embodiments a conformal mapping calculation may be performed off-line, or before actual images are collected from a patient. In one embodiment, a conformal mapping calculation may include creating a matrix or other data structure which maps each pixel in the transformed shape (e.g. the hexagonal window) to a pixel in the original shape (e.g. circle). The matrix may be used to transform each image from the original shape to the transformed shape.

If offline computation is used, mapping may be done once, for example before images for a particular patient are gathered (and the mapping may be later applied to images actually gathered from a patient), or before the images are fully processed (and the mapping may be subsequently applied during processing). A mapping may be computed from a canonical circle to a canonical hexagon, or from a circle as defined from data received from a particular capsule. This transformation may be the conformal mapping. This initial computation may be done only once (if the valid mask is known or pre-determined, or deemed valid for all capsules), and the results saved to a file (in some resolution) or may be part of display software or a display system. This initial computation may be done once per capsule used, and the results applied to images for that particular capsule, as the input mask may vary from video to video or from capsule to capsule. The computation may be applied to every frame gathered from a patient.

Online computation may also be used in some embodiments.

It may be advantageous to reduce the distinction between adjacent image windows 630 in order to attract less attention of the viewer to the connecting or border areas in the combined image. In some embodiments, the edges connecting adjacent image windows 630 may be blurred or made indistinct. Different methods of blurring the edges exist. For example, interpolation or inpainting may be used. Border areas between the image windows colors may be smoothed, and/or the image pixels in the areas connecting a plurality of images which may be displayed simultaneously may be interpolated.

Modifications such as inpainting or interpolation may cause spreading of the colors, or may cause visible artifacts e.g. stripes, seams, blocks or misfitting edges to appear in the combined image.

In addition or instead, texture synthesis may be used to reduce the artifacts or the chance of artifacts appearing in the displayed images. For example, patch-based texture synthesis may be used in order to smooth the bordering edges and reduce the distinction between the borders displayed images. In some embodiments, in order to minimize the appearance of artifacts in the displayed image, when a viewer stops the image stream in order to closely view a certain image or portion thereof, the original (e.g., without modifications such as inpainting or interpolation) images may be displayed next to the combined synthesized images 630, and verification of possible artifacts may be performed immediately by the viewer. In some embodiments, texture synthesis may be used in combination with interpolation or inpainting, or instead of inpainting techniques.

Other user interface features may be used, and combinations of editing tools may be used.

Embodiments of the present invention may include apparatuses for performing the operations described herein. Such apparatuses may be specially constructed for the desired purposes, or may include computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Embodiments of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Features of various embodiments discussed herein may be used with other embodiments discussed herein.

The system and method of the present invention may allow an image stream to be viewed in an efficient manner and over a shorter time period. It will be appreciated by persons skilled in the art that the present invention is not limited by what has been particularly shown and described hereinabove. Rather the scope of the invention is defined by the claims that follow.

1. A method for displaying an image stream captured by an in vivo imaging capsule, the method comprising:
receiving images from an in vivo imaging capsule, and generating an original image stream from the images;
selecting a first subset of images from the original image stream for display as a reduced image stream in a main image window on a monitor, wherein the selection of the first subset of images is performed according first selection method;
obtaining a second subset of images from the original image stream, by subtracting the first subset of images from the original image stream;
selecting a first image from the first subset of images to be displayed in the main image window during a first time slot;
selecting at least one image from the second subset of images to be displayed in a peripheral window on the monitor, wherein the selection of the image from the second subset is according to a second selection method; and
displaying, substantially simultaneously during the first time slot, the selected image from the first subset of images in a main image window, and the at least one selected image from the second subset of images in a peripheral window.

2. The method according to claim 1, further comprising arranging the selected images from the second subset in adjacent peripheral windows, such that the adjacent peripheral windows are positioned at least partially surrounding the main image window.

3. The method according to claim 2 wherein the size of the main image window is larger than the size of the adjacent peripheral windows.

4. The method according to claim 1 wherein the time of capture of the at least one image from the second subset of images is substantially adjacent to the time of capture of said first image.

5. The method according to claim 4 wherein the time difference between the time of capture of the at least one image from the second subset of images is less than a predetermined time duration before or after the time of capture of said first image.

6. The method according to claim 1 wherein the original image stream has an order, and wherein the at least one image from the second subset of images is, in the order, located less than a predetermined number of images before or after said first image.

7. The method according to claim 1, further comprising selecting images from the first subset of images to be repeated in a subsequent time slot.

8. The method according to claim 7 wherein the repeated images are displayed in peripheral image windows.

9. The method according to claim 1 wherein the first selection method comprises selecting images based on likelihood of pathology detected.

10. The method according to claim 1 wherein the second selection method comprises selecting a representative image from a group of similar images captured sequentially.

11. The method according to claim 1, wherein the peripheral windows are hexagonal shaped.

12. The method according to claim 1 comprising smoothing the borders between adjacent image windows.

13. A system for displaying an image stream captured by an in vivo imaging capsule comprising:
a processor to:
detect similarity between two or more images;
select a first subset of images from an original image stream for display as a reduced image stream according to a first selection method;
subtract the first subset of images from the original image stream to obtain a second subset of images;
select a first image from the first subset of images to be displayed in a main image window during a first time slot; and
select, according to a second selection method, at least one image from the second subset of images to be displayed in a peripheral image window during the first time slot; and
a monitor to display substantially simultaneously during the first time slot, the selected first image in a main image window, and to display the selected at least one image from the second subset of images in a peripheral window.

14. The system of claim 13 wherein the similarity detector is to detect similarity between images which are candidates to be repeatedly displayed across adjacent time slots.

15. The system of claim 13 wherein the size of the central window is larger than the size of the peripheral window.

16. The system of claim 13 wherein the time of capture of the at least one image from the second subset of images is substantially adjacent to the time of capture of said first image from the first subset of images.

17. The system of claim 13 wherein the time difference between the time of capture of the at least one image from the second subset of images is less than a predetermined time duration before or after the time of capture of said first image from the first subset of images.

18. The system of claim 13 wherein the original image stream has an order, and wherein the at least one image from the second subset of images is, in the order, located less than a predetermined number of images before or after said first image.

19. The system of claim 13 wherein the processor is to determine which images from the first subset of images displayed in the first time slot to repeat in a subsequent time slot based on predetermined criteria.
